(19) United States
(12) Patent Application Publication
(10) Pub. No.: US 2005/0047568 A1
(43) Pub. Date: Mar. 3, 2005

(54) Telephone number transfer

(76) Inventor: David Nichols, Armonk, NY (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/925,425

(22) Filed: Aug. 25, 2004

Related U.S. Application Data
(60) Provisional application No. 60/497,729, filed on Aug. 25, 2003.

(51) Int. Cl. H04M 15/00

(52) U.S. Cl. 379/114.05; 379/114.01

(57) ABSTRACT

Provided is a method, system and software for facilitating transfer of authorized use of a telephone number from a first user to a second user, including receiving an offer to sell from the first user, transmitting the offer to sell to the second user, receiving an offer to buy from the second user, transmitting the offer to buy to the first user, receiving a request from the first user to have the authorized use of the telephone number transferred to the second user, and transmitting the request to a telephone carrier. Also included are methods, systems and software for presenting advertisements to users and charging users and advertisers fees.

### CROSS-REFERENCE TO RELATED APPLICATION

The present application claims the benefit of U.S. Provisional Application No. 60/497,729, filed Aug. 25, 2003, the disclosure of which is hereby incorporated herein.

### BACKGROUND OF THE INVENTION

The FCC (Federal Communications Commission) has mandated local number portability (“LNP”). LNP means that a user can retain his phone number when switching telephone service providers. This applies to local wireline numbers (i.e., numbers served by physical lines) as well as cellular (wireless) numbers.

The FCC has also mandated service provider portability. Service provider portability is the ability to maintain one's number when changing service providers.

Thus, the FCC envisions a day when users will retain their telephone numbers no matter what company is providing service and no matter whether that service is through a landline or is wireless.

In the cellular arena, telephone numbers are typically distributed in blocks, with each cellular company being allocated particular blocks of telephone numbers. The cellular companies thereby effectively “own” the telephone numbers within their allocated block and lease them out to their users. This created a significant problem for users, however, since a user would lose their existing telephone number if they switch carriers.

With wireless number portability (“WNP”), users are free to keep their telephone numbers when they switch cellular carriers. Thus, the user effectively “owns” the number after they first receive it, regardless of which company the user receives wireless service from.

This new environment provides an opportunity for the present invention. A method and system that allows for telephone numbers to be traded between users is thus desirable.

It is also desirable that a marketplace be provided for the sale and purchase of telephone numbers by users, without the direct involvement of telephone carriers.

It is also desirable that a forum be provided for telephone users to buy or sell their telephone numbers and thus have an improved degree of choice over what number(s) they have.

It is also desirable that telephone users be able to derive a benefit from the sale of their right to use a telephone number.

### SUMMARY OF THE INVENTION

One aspect of the present invention provides a method relating to transferring the authorized use of a telephone number from a first user to a second user. The method includes receiving an offer to buy the authorized use of the telephone number from the second user, transmitting the offer to buy to the first user, receiving a request from the first user to have the authorized use of the telephone number transferred to the second user, and transmitting a request to a telephone carrier to have the authorized use of the telephone number transferred from the first user to the second user.

Another aspect of the invention includes charging a fee to the first user.

A further aspect of the invention includes charging a fee to the second user.

Another aspect of the invention includes charging a fee for transmitting the request to the telephone carrier to transfer the authorized use of the telephone number.

Another aspect of the invention further includes charging a fee to advertisers for advertisements presented to the first user or the second user while performing the method.

In an aspect of the invention the advertisements are for the sale of telecommunications equipment or services. In another embodiment the advertisements presented are based on the telephone number of the first user or second user.

In another aspect of the present invention, the advertisements presented are based on the telephone number whose authorized use is being transferred.

Another aspect of the invention includes notifying users when their telephone service contract is about to expire.

In a preferred embodiment of the invention, a method of facilitating transfer of the authorized use of a telephone number from a first user to a second user is included. The method comprises receiving an offer to sell the authorized use of the telephone number from the first user, transmitting the offer to sell to the second user, receiving an offer to buy the authorized use of the telephone number from the second user, and transmitting the offer to buy to the first user.

A further aspect of the present invention comprises receiving a request from the first user to have the authorized use of the telephone number transferred to the second user, and transmitting the request to a telephone carrier.

Another aspect of the invention includes a system for transferring the authorized use of a telephone number. The system includes a first user, a second user, and a broker accessible by the first user and the second user. The broker is also in communication with a telephone carrier. Further, the broker includes a computer system having memory and an associated processor. The processor is configured to execute computer instructions for receiving an offer to the sell authorized use of a telephone number from the first user, transmitting the offer to sell to the second user, receiving an offer to buy the authorized use of the telephone number from the second user, and transmitting the offer to buy to the first user.

A further aspect of the present invention also provides that the processor is further configured to execute computer instructions for receiving a request from the first user to have the authorized use of the telephone number transferred from the first user to the second user, and for transmitting the request to the telephone carrier.

Another aspect of the invention includes a telephone number transfer system including a networked broker in communication with a first user, the broker configured to present the first user with the opportunity to offer the authorized use of a telephone number for sale.

In another aspect of the invention, the broker is further configured to receive an offer to sell the authorized use of the telephone number from the first user.

In another aspect of the invention, the broker is further configured to present the offer to sell the authorized use of the telephone number to the second user.

In another aspect of the invention, the broker is further configured to receive an offer to buy the authorized use of the telephone number from the second user.

In another aspect of the invention, the broker is further configured to present the second user's offer to buy the authorized use of the telephone number to the first user.

In another aspect of the invention, the broker is further configured to receive an acceptance of the second user's offer to buy the authorized use of the telephone number from the first user, and to present the acceptance to the second user.

In another aspect of the invention, the broker is further configured to receive a request from the first user to transfer the authorized use of the telephone number from the first user to the second user.

In another aspect of the invention, the broker is further configured to transmit the request to transfer the authorized use of the telephone number from the first user to the second user to a telephone carrier in communication with the broker.

Another aspect of the invention includes telephone number transfer software, which includes server software operable to receive offers to buy or sell authorized use of telephone numbers over a computer network, database software operable to store user identification, telephone number, and carrier information, communication software operable to communicate with one or more telephone carriers, and software for displaying one or more offers to buy or sell the authorized use of telephone numbers to one or more users.

In a further aspect of the invention, software operable to remind a user when the user's telephone service contract is about to expire is included.

Another aspect of the invention includes software operable for displaying one or more advertisements to one or more users.

### BRIEF DESCRIPTION OF THE DRAWINGS

FIG. 1 is a schematic diagram of an exemplary telephone number transfer system in accordance with an embodiment of the present invention;

FIG. 2 is a schematic diagram of an exemplary telephone number transfer system in accordance with an embodiment of the present invention;

FIG. 3 is a flowchart of an exemplary embodiment of the method of the present invention from the viewpoint of an exemplary broker;

FIG. 4 is a flowchart of an exemplary embodiment of the method of the present invention from the viewpoint of an exemplary first user;

FIG. 5 is a flowchart of an exemplary embodiment of the method of the present invention from the viewpoint of an exemplary second user; and

FIG. 6 is a flowchart of an exemplary embodiment of the method of the present invention from the viewpoint of an exemplary telephone carrier.

### DETAILED DESCRIPTION

“Telephone carrier” as used herein means any entity able to assign or transfer the right to authorized use of one or more telephone number to or between users.

“User” defines any entity having a need or use for the right to authorized use of one or more telephone numbers. It is also used herein to refer to the customers of telephone carriers.

“Authorized use of a telephone number” refers to the assignment, typically made by telephone carriers, which associate a given user with a given telephone number. Authorized use of a telephone number is similar to ownership of the telephone number in that it can be transferred between users. The term “right to use” is also used herein to indicate authorized use of.

“Telephone number” as used herein refers to the part of a telephone number whose authorized usage may be transferred from one user to another user. This definition of telephone number may become more inclusive over time, as area codes become less tied to geographical regions.

“Telephone number transfer”, “sale of a telephone number”, “buy the telephone number”, and other similar expressions as used herein generally refers to the transfer of the authorized use of the telephone number in question from one user to another. Any reference or inference made herein to any telephone number as saleable goods refers to the authorized use of the telephone number.

“Broker” as used herein is generally any entity able to communicate with one or more users by any means to receive offers to sell and buy the authorized use of one or more telephone numbers. A broker may also communicate with a telephone carrier to pass along requests to transfer the authorized use of one or more telephone numbers from one user to another. Brokers may comprise computer hardware, firmware, software, human elements. They may exist as a single entity, be composed of multiple entities, or may be part of another entity.

“Buyer” as used herein generally represents users having or desirous of being the authorized user of one or more telephone numbers.

“Seller” as used herein generally represents users who are the authorized user of one or more telephone numbers and desire to transfer their authorized use to another user.

“Buy” and “sell” as used herein also includes barter or exchange, as well as gifting.

An embodiment of the present invention advantageously provides buyers the ability to see what area codes are in operation in their geographical area, and what telephone numbers have been listed by sellers which authorized use of is for sale.

Certain embodiments of the present invention advantageously provide a system and method allowing the buyer who finds a telephone number they are interested in to send a message to the seller, make an offer to the seller, and purchase the authorized use of the telephone number from the seller.

Certain embodiments of the present invention permit the buyers and sellers to work out the timing of the transfer of authorization to use the telephone numbers, within the governing framework of agreements with the telephone carriers or service providers.

The preferred methods and systems described herein can be realized without much additional manpower or special training at the broker or telephone carrier. Of course, some degree of planning and careful design is required to set the system up.

An additional advantage provided by forms of the present invention is that the sellers may list their telephone numbers whose authorized use they wish to sell.

Another advantage afforded by certain preferred embodiments of the present invention is that credit card and/or other information may be used to verify authorized use of the telephone number.

Another advantage of embodiments of the present invention is that authorized use of telephone numbers by sellers may be confirmed by callback or other independent methods.

Another advantage of certain embodiments of the present invention is that a seller may determine when he no longer wishes to be the authorized user of a telephone number.

Another advantage of embodiments of the present invention is that the seller may set the parameters and price at which he is willing to sell authorized use of the telephone number. For example, the seller may elect a sale price that changes over time, e.g., no change over time; price declines by a fixed amount at fixed intervals; or price declines by a fixed percentage over fixed intervals. Any other conceivable and legal price variation may alternatively be employed.

Another advantage of certain embodiments of the invention is that the seller is able to derive a benefit from the sale of their right to use a telephone number.

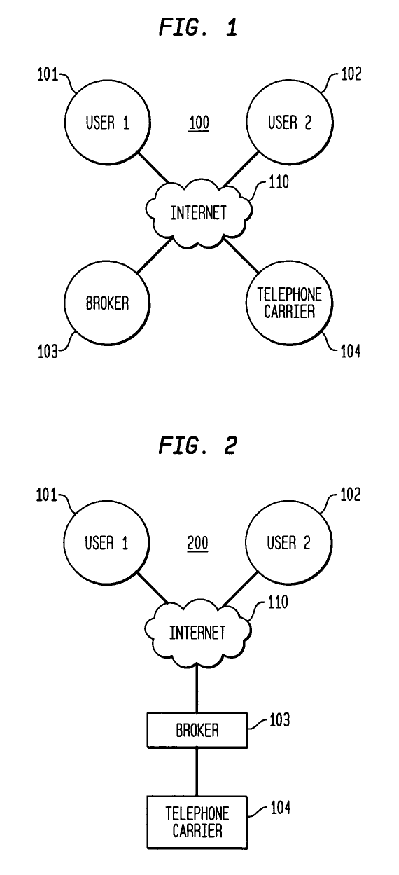

A telephone number transfer system 100 in accordance with an embodiment of the present invention is depicted in FIG. 1.

A first User 101 and a second User 102 (herein referred to as “User 1” and “User 2”, respectively, or as “User”, collectively) are depicted. Users may be individuals, groups, businesses, or other entities. Users refer to any entity having or desiring rights to a telephone number. Although only two users are depicted in FIGS. 1 and 2, more than two users are envisioned for an embodiment of the system. Additional users are not depicted for clarity.

In a preferred embodiment, users are in communicative connection with a network, such as the Internet 110, as depicted in FIG. 1. Any physical means of connecting the users to the network may be employed. For example, users may connect to the Internet 110 via a personal computer running Internet browser software and having a modem dialup; digital subscriber line (DSL), cable modem or satellite Internet connection. Users may also connect to a network via personal handheld devices, such as Blackberry™, or other wireless device, without limitation.

One aspect of users in an embodiment of the present invention is their relationship to and need for the right to use telephone numbers. In a telephone number transfer system as depicted in FIG. 1, each telephone number transfer will involve at least a seller, such as User 1 101, and a buyer or a party acting on behalf of a perspective buyer, such as User 2, 102. User 1 101 and User 2 02 are also referred to herein as “seller” and “buyer”; respectively, for demonstrative purposes only, i.e., there is nothing preventing the users each from performing in the role of buyer or seller in other transactions. Indeed, it is envisioned that such role reversal between 1 101 and User 2 102 may occur at any time and is a desired feature of the telephone number transfer system 100.

As mentioned, the users 101, 102 and in communication with a network, such as the Internet 110, as depicted. This network may take any for, e.g., the depicted Internet 110, an Intranet, or any communications network able to communicate with the Users 101, 102. The Internet 110 is the network used in a preferred embodiment due in part to its universal accessibility. Other networks may be used instead.

Also in communicative connection with the network in an embodiment is the broker 103. The broker 103 is any entity able to communicate with the Users 101, 102 over a network such as the Internet 110. In a preferred embodiment, the broker 103 is in connection with the Internet 110. Any means may be used to connect the broker 103 to the Internet 110.

It is not necessary for the broker 103 to communicate with the seller User 1 101, at the same time or in the same way as with the buyer, User 2 102. For example, the broker 103 may communicate with the seller over the Internet using the seller's wireless communications device, and with the buyer using the buyer's personal computer. Also, the broker 103 may receive an offer sell the rights to use a telephone number from the seller on a particular day and time, and an offer to buy the right to use the telephone number from the buyer at another day and time.

In a preferred embodiment, the broker 103 incorporates one or more websites with one or more web pages on the Internet 110 to facilitate communications with the Users 101, 102. For example, the broker 103 may present a web page to the seller, User 1 101, offering the seller to list a telephone number for sale with the broker 103. The broker 103 may then place the seller's rights to use the listed telephone number for sale on the same or another web page for the buyer, User 2 102, to view. The buyer may then offer to buy the right to use the telephone number from the seller by responding to the broker 103 and its listing on the broker's website.

It is not necessary, although not prohibited, that the buyer and seller are informed of each other's identities, since their communication is through the broker 103.

In furtherance to the preferred embodiments described above, the broker 103 may forward the offer to buy the right to use the telephone number to the seller, User 1 101. In an embodiment, the seller may then indicate its approval of the proposed sale by sending a message to the broker 103 indicating that the right to use the telephone number is to be transferred from the seller, User 1 101, to the buyer, User 2 102.

In an embodiment, the broker 103 may function as an intermediary for the payment from the buyer to the seller. For example, the broker 103 may require payment from the buyer at the time the buyer indicates the decision to buy the right to use the telephone number. Payment may take the form of cash transfer, credit or debit card, or any other means of payment. In another embodiment, the broker 103 may not serve as an intermediary for the payment from the buyer to the seller. In this embodiment, the broker 103 may serve to provide the buyer with instructions for payment from the seller. Alternatively, the buyer and seller may negotiate a non-monetary exchange for the buyer to obtain the seller's offered telephone number.

Once the broker 103 has received the message from the seller, User 1 101, indicating that the right to use the telephone number is to be transferred from the seller to the buyer, User 2 102, the broker may forward to the buyer an indication that the seller has approved the transfer. In a preferred embodiment, the broker 103 may communicate the seller's message to transfer the telephone number to a telephone carrier 104.

The telephone carrier 104 in an embodiment is the entity that assigns the right to use the telephone number to be transferred. In some cases, the telephone carrier 104 may actually be several entities (not depicted) which together or separately may assign or change the assignment of the telephone number.

As with the Users 101, 102, only a single telephone carrier 104 is depicted in FIG. 1 for simplicity. It is understood that a system in accordance with an embodiment of the present invention may include one or more telephone carriers. Actions attributed herein to a single telephone carrier 104 may alternatively be attributed to multiple telephone carriers.

Upon receipt of the message from the seller, User 1 101, through the broker 103, the telephone carrier may then transfer the right to use the telephone number from User 1 101 to User 2 102.

Whether one or more telephone carriers 104 are used in an embodiment, the telephone carriers 104 may require payment of a telephone number transfer or other fees. Such payment may be received by the telephone carriers 104 from the Users 101, 102 through the broker 103, or by a third party (not depicted).

In response to the message to transfer the telephone number from the seller to the buyer, in a preferred embodiment, the telephone carrier may then transfer the telephone number from the seller to the buyer.

In a preferred embodiment, the broker may communicate with the one or more carriers 104 through the Internet. As with all the Internet communications described herein, it is preferable that secure and encrypted Internet communications be employed, such as the Internet communications security provided by the Microsoft Internet Explorer® or the Netscape®.

FIG. 2 depicts an embodiment of the present invention wherein the broker 103 is in direct communications with a telephone carrier 104. It may be beneficial for the broker 103 and the telephone carrier 104 to be in communication that does not employ a public network, such as the Internet 110. For example, a greater degree of security and greatly reduced opportunity for interference, such as hacking, is available with a secure, private communications channel between the broker 103 and the telephone carrier 104.

Moreover, in an embodiment, the broker 103 and the telephone carrier 104 may be part of the same business entity (not depicted). In such an embodiment, the broker 103 an telephone carrier 104 refer to the sub-entities within the business entity, and they may advantageously use an internal network to communicate. The broker 103 and telephone carrier 104 may alternatively use the public Internet to communicate in an embodiment.

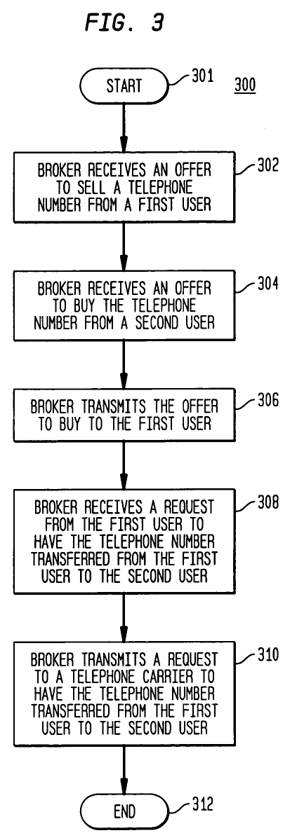

FIG. 3 is a flowchart 300 depicting the process of a telephone number transfer in accordance with an embodiment of the present invention from the perspective of a broker 103. To begin the process 301, the broker receives an offer to sell the right to use a telephone number from a first User 302.

The broker may receive the first user's offer to sell the right to use the telephone number in several ways. For example, the broker may maintain an Internet website with a web page which the first user can use to list the offer to sell the right to use the telephone number. Alternatively, the broker may provide the first user with an e-mail address to which the first user may send the offer to sell. Other means of communicating the seller's offer to the broker may also be employed.

The broker also receives an offer to buy the right to use the telephone number from a second User 304. In an embodiment, the second user 304 may first learn of the first User's offer to sell the right to use the telephone number from the broker, although this is not required. For example, in an embodiment, the second user may contact the broker to express an interest in buying the right to use the telephone number even before the broker received the first User's offer to sell the right to use the telephone number.

In an embodiment, the broker may advertise, e.g. via one or more web pages, for both or either buyers and sellers of telephone numbers. In such an embodiment, the order of receipt of offers to buy and offers to sell a telephone number is not limiting.

Additionally, the broker may offer advertisements and other goods and services to both or either the first or second user, or any other person viewing the broker's website. For example, in an embodiment, the broker may present a web page to the Users 101, 102 allowing the User 101, 102 to post offers to buy or sell the right to use telephone numbers, and displaying to the Users 101, 102 advertisement for goods or services for sale by the broker 103, or by one or more third parties (not depicted). When such an advertisement is provided by a third party, the broker 103 may charge the third party a fee for presenting its advertisement to the Users 101, 102.

In another embodiment, the broker 103 may present to a User 101, 102 a notification that the user's existing contract with a telephone carrier is due for renewal. The broker 103 may receive information regarding the User's contract either from a telephone carrier or from the User 101, 102. Contract renewal time is an advantageous time to present a User 101, 102 with opportunities to buy or sell a telephone number.

In an embodiment, once the broker 103 has received an offer to buy the right to use the telephone number from the second user 304, the broker 103 transmits the offer to buy to the first user 306. The broker 103 may transmit the second User's offer to buy to the first User using any of several ways. For example, the broker may send an e-mail to the first user informing the first user of the second User's offer. Alternatively, the broker may update a web page accessible to the first user to indicate the second user's offer. In such an embodiment, the broker may transmit the second User's offer to the first user by multiple methods of transmission, including but not limited to e-mail, web pages, direct telephone calls, mail, as well as other methods, without limitation.

In one embodiment, the second User's offer to buy the right to use the telephone number may include payment for the telephone number, or information pertaining to such payment. For example, the second User's offer may include a credit or debit card number and authorization for either the broker or the first user to charge the credit or debit card. In another such embodiment, the second User may include electronic funds transfer information in its offer to buy. In such an embodiment, the first user may have previously provided the broker or the second user, or both, with information for an account into which to transfer the payment to.

In an embodiment, once the first user has been notified of the second user's offer to buy the right to use the telephone number, the first user may take one of several actions. First the first user may reject the offer to buy, thereby terminating the process Second, the first user may consider if other offers to buy have been received, an may act in accordance with its best interests as perceived by the first user. Ultimately, the first user may choose to accept the second User's offer to buy the telephone number by sending the broker 103 a request to have the right to use the telephone number transferred from the first user to the second user 308. In an embodiment, the first user may also accept payment for the right to use the telephone number from either the broker 103 or from the second user.

In an embodiment, the broker 103 may then transmit the request from the first user to transfer the request from the first user to transfer the telephone number from the first user to the second user to the telephone carrier 310. At this point, in an embodiment the process is at its completion 312.

In one embodiment of the present invention, the broker 103 and the telephone carrier 104 communicate via the Internet. In other embodiments, the communication between the broker 103 and the telephone carrier 104 is via other communication modalities.

In another embodiment, the broker 103 and the telephone carrier 104 are part of the same business entity, and may communicate over a non-public network or other private communication channel.

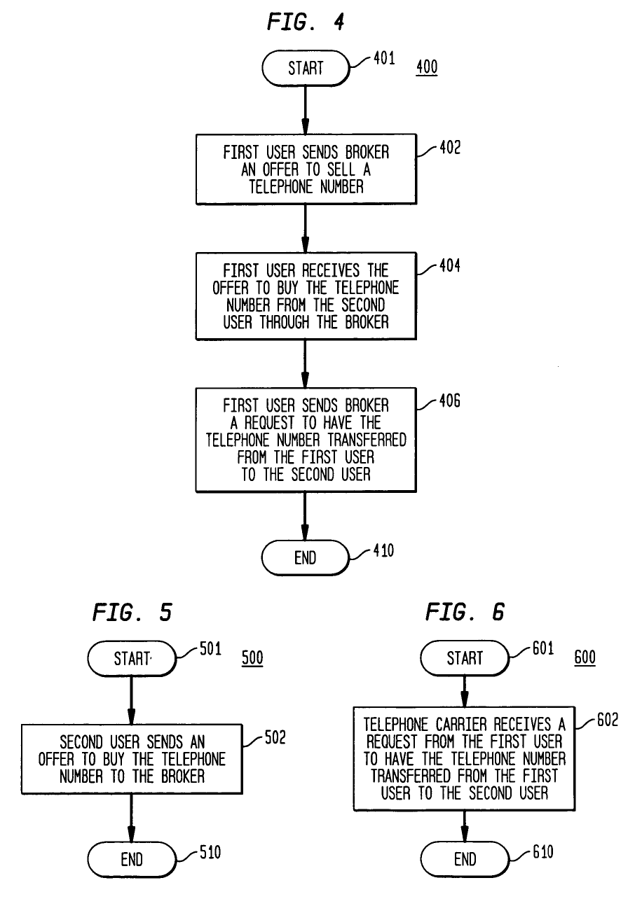

FIG. 4 is a flowchart 400 depicting a telephone number transfer in accordance with an embodiment of the present invention from the perspective of a first user, who has rights to use a telephone number they wish to offer for sale.

The process begins 401 when the first user sends the broker 103 an offer to sell the right to use a telephone number 402. The first User may send the offer to sell the right to use the telephone number in response to a query or communication from the broker 103, a telephone carrier 104, or a second user. In an embodiment, the first user may send the offer to sell using an Internet web page provided by the broker 103.

In an embodiment, the first user may receive an offer from a second user to buy the right to use the telephone number 404. In an embodiment, the offer to buy may be received by the first user after and in response to the first user's offer to sell. In another embodiment, the offer to buy may be received regardless of whether the first User has offered to sell the right to use the telephone number. In such an embodiment, the offer to buy the right to use the telephone number is unsolicited. In an embodiment, if the first User determines to accept the second User's offer to buy the right to use the telephone number, the first User sends the broker a request to have the right to use the telephone number transferred from the first User to the second User 406, thereby completing the process 410 from the first User's perspective.

FIG. 5 is a flowchart 500 depicting the process of a telephone number transfer in accordance with an embodiment of the present invention from the perspective of a buyer, also called a “second user” herein. The second user may send an offer to buy the right to use a telephone number to the broker 103. In an embodiment, this offer may be in response to an offer to sell the right to use the telephone number. In another embodiment, the offer to buy the right to use the telephone number 502 may be made without the second User having first received an offer to sell the right to use the telephone number from a first user.

The steps performed by a telephone carrier 104 in an embodiment of a telephone carrier 104 in an embodiment of a telephone number transfer in accordance with the present invention are presented in the flowchart 600 of FIG. 6.

In a preferred embodiment, the telephone carrier 104 receives a request from the first user to have the right to use the telephone number transferred from the first User to the second User 602.

In another embodiment, the right to use the telephone number is transferred to a third party for storage. The third party may be the broker.

In another embodiment, the telephone carrier 104 may receive the telephone number transfer request from the first User 101.

In a preferred embodiment, the telephone carrier 104 may honor the request to transfer the telephone number by actually performing the requested transfer.

Portability laws may assist in embodiments of the present invention by requiring that carriers allow users who switch to another carrier to port the telephone number to which the user has the right to use to the new carrier. The following Scenarios are demonstrative of advantages provided by the present invention in combination with appropriate portability laws.

Scenario 1: Both the Buyer and Seller are with the same telephone carrier, Carrier-A. Carrier-A does not 105458-52291 permit at-will telephone number transfers between users. If Carrier-A refuses to allow the transfer of the right to use the telephone number from Seller to Buyer, both the Buyer and Seller could go to another carrier, Carrier-B. Carrier-A would be forced to transfer the right to use the telephone number to Carrier-B, because of portability laws. Carrier-B would then be free to transfer the right to use the telephone number to the Buyer.

Scenario 2: Buyer is with Carrier-A, Seller is with Carrier-B. Neither telephone carrier agrees to transfer the right to use the telephone number from Seller to Buyer. Both Buyer and Seller could go to another carrier, Carrier-C, which is willing to transfer the right to use the telephone number from Seller to Buyer. Again, Carrier-B would be forced to transfer the right to use the telephone number to Carrier-C, because of portability laws.

Scenario 3: Buyer is with Carrier-A, Seller is with Carrier-B. Carrier-A agrees to transfer the right to use the telephone number from Seller to Buyer. Carrier-B refuses. Since Carrier-B will not transfer the right to use the number directly, the Seller may move his account to Carrier-A. Again, due to portability laws, Carrier-B would be forced to transfer the right to use the telephone number to Carrier-A.

Scenario 4: Buyer is with Carrier-A, Seller is with Carrier-B. Carrier-B agrees to transfer the right to use the telephone number from Seller to Buyer. Carrier-A does not. The Buyer may move his account to Carrier-B. After the transfer of the right to use the telephone number, the Buyer is free to move his account back to Carrier-A.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method relating to the authorized use of a telephone number comprising the steps of:
receiving an offer from a second user to buy the right for the authorized use of the telephone number;
transmitting the offer to buy to a first user (who is the authorized user of the telephone number);
receiving a request from the first user to have the authorized use of the telephone number transferred to the second user; and
transmitting a request to a telephone carrier to have the authorized use of the telephone number transferred from the first user to the second user.

2. The method according to claim 1, further comprising charging a fee to the first user.

3. The method according to claim 1, further comprising charging a fee to the second user.

4. The method according to claim 1, further comprising charging a fee for transmitting the offer to buy.

5. The method according to claim 4, further comprising charging a fee for transmitting the request to have the authorized use of the telephone number transferred from the first user to the second user.

6. The method according to claim 1, further comprising charging a fee to advertisers for advertisements presented to the first user or the second user while performing the method.

7. The method according to claim 6, wherein the advertisements presented are based on the telephone number of the first user or second user.

8. The method according to claim 6, wherein the advertisements presented are based on the telephone number whose authorized use is being transferred.

9. The method according to claim 1, wherein the advertisements are for the sale of telecommunications equipment or services.

10. The method according to claim 1, further comprising reminding a user when a telephone service contract of the user is about to expire.

11. A method of facilitating transfer of the authorized use of a telephone number from a first user to a second user, the method comprising:
receiving an offer to sell the authorized use of a telephone number from the first user;
transmitting the offer to sell to the second user;
receiving an offer to buy the authorized use of the telephone number from the second user; and
transmitting the offer to buy to the first user.

12. The method according to claim 11, further comprising receiving a request from the first user to have the authorized use of the telephone number transferred to the second user.

13. The method according to claim 12, further comprising transmitting a request to a telephone carrier to have the authorized use of the telephone number transferred from the first user to the second user.

14. The method according to claim 13, further comprising charging a fee for receiving an offer to sell the authorized use of the telephone number.

15. The method according to claim 13, further comprising charging a fee for transmitting the offer to sell to the second user.

16. The method according to claim 13, further comprising charging a fee for receiving an offer to buy the authorized use of the telephone number from the second user.

17. The method according to claim 13, further comprising charging a fee for transmitting the offer to buy the authorized use of the telephone number from the second user to the first user.

18. The method according to claim 13, further comprising charging a fee for transmitting a request to a telephone carrier to have the authorized use of the telephone number transferred from the first user to the second user.

19. The method according to claim 13, further comprising transmitting an advertisement to the second user.

20. The method according to claim 19, further comprising charging a fee for transmitting the advertisement.

21. The method according to claim 11, further comprising reminding a user when the user's telephone service contract is about to expire.

22. A telephone number transfer system comprising:
a broker accessible by a first user and a second user, the broker in communication with a telephone carrier, the broker comprising a computer system having memory and an associated processor, the processor configured to execute computer instructions for:
receiving an offer to sell authorized use of a telephone number from the first user;
transmitting the offer to sell to the second user;
receiving an offer to buy the authorized use of the telephone number from the second user; and
transmitting the offer to buy to the first user.

23. The telephone number transfer system according to claim 22, wherein the processor is further configured to execute instructions for receiving a request from the first user to have the authorized use of the telephone number transferred from the first user to the second user.

24. The telephone number transfer system according to claim 23, wherein the processor is further configured to execute instructions for transmitting the request to the telephone carrier to have the authorized use of the telephone number transferred from the first user to the second user.

25. A telephone number transfer system comprising
a networked broker in communication with a first user, the broker configured to present the first user with the opportunity to offer authorized use of a telephone number for sale.

26. The telephone number transfer system according to claim 25, wherein the broker is further configured to receive an offer to sell the authorized use of the telephone number from the first user.

27. The telephone number transfer system according to claim 26, wherein the broker is further in communication with a second user, and the broker is further configured to present the offer to sell the authorized use of the telephone number to the second user.

28. The telephone number transfer system according to claim 27, wherein the broker is further configured to receive an offer to buy the authorized use of the telephone number from the second user.

29. The telephone number transfer system according to claim 28, wherein the broker is further configured to present the second user's offer to buy the authorized use of the telephone number to the first user.

30. The telephone number transfer system according to claim 29, wherein the broker is further configured to receive an acceptance of the second user's offer to buy the authorized use of the telephone number from the first user, and to present the acceptance to the second user.

31. The telephone number transfer system according to claim 29, wherein the broker is further configured to receive a request from the first user to transfer the authorized use of the telephone number from the first user to the second user.

32. The telephone number transfer system according to claim 31, wherein the broker is further in communication with a telephone carrier, and the broker is further configured to transmit the first user's request to transfer the authorized use of the telephone number from the first user to the second user to the telephone carrier.

33. The telephone number transfer system according to claim 26, wherein the broker is further configured to charge the first user a fee.

34. The telephone number transfer system according to claim 28, wherein the broker is further configured to charge the second user a fee.

35. The telephone number transfer system according to claim 32, wherein the broker is further configured to charge a fee.

36. The telephone number transfer system according to claim 32, wherein the broker is further configured to present telecommunications equipment for sale to the first and second users.

37. Telephone number transfer software, comprising:
server software operable to receive offers to buy or sell authorized use of telephone numbers over a computer network;
database software operable to store user identification, telephone number, and carrier information;
communication software operable to communicate with one or more telephone carriers; and
software for providing display information regarding one or more offers to buy or sell authorized use of telephone numbers to one or more users.

38. The software according to claim 37, further comprising software operable to remind a user when the user's telephone service contract is about to expire.

39. The software according to claim 37, further comprising software operable for displaying one or more advertisements to one or more users.

40. A telephone number transfer system comprising:
a broker accessible by one or more first users and a second user, the broker in communication with a telephone carrier, the broker comprising a computer system having memory and an associated processor, the processor configured to execute computer instructions for:
receiving offers to sell the authorized use of one or more telephone numbers from the first users;
transmitting the offers to sell to the second user;
receiving an offer to buy the authorized use of one of the telephone numbers from the second user; and
transmitting the offer to buy to the first user which offered to sell the authorized use of the telephone number.
